(19) United States
(12) Patent Application Publication
(10) Pub. No.: US 2019/0012330 A1
(43) Pub. Date: Jan. 10, 2019

(54) VARIOUS METHODS FOR DISPLAYING VENUE INFORMATION ON A VENUE MAP

(71) Applicant: BROKER GENIUS, INC., FAR ROCKAWAY, NY (US)

(72) Inventors: Shmuel Sherman, Valley Stream, NY (US); Jim McGowan, Flemington, NJ (US)

(21) Appl. No.: 16/031,955

(22) Filed: Jul. 10, 2018

Related U.S. Application Data
(60) Provisional application No. 62/530,836, filed on Jul. 10, 2017.
(60) Provisional application No. 62/530,831, filed on Jul. 10, 2017.
(60) Provisional application No. 62/530,833, filed on Jul. 10, 2017.
(60) Provisional application No. 62/530,834, filed on Jul. 10, 2017.

(51) Int. Cl. G06F 17/30; H04W 4/021; G06T 11/00

(52) U.S. Cl. CPC G06F 17/30241; G06T 11/001; G06F 17/30994; H04W 4/021

(57) ABSTRACT

A system provided includes at least one database configured to store credential inventory data, wherein the credential inventory data includes at least a data object corresponding to each of the plurality of access credentials, wherein the data object includes a value indicative of the availability of the associated access credential. A processor is provided that is configured to access a virtual map of the given event wherein the virtual map includes a plurality of sections. The processor is also configured to receive from one of the one or more remote databases the credential inventory data and assign, using the features associated with each of the plurality of access credentials, each of the plurality of access credentials to one of the plurality of sections of the virtual map. The processor is further configured to generate a visual marker for each of the plurality of section as a function of the percentage of access credential available within a given section.

### CROSS REFERENCE TO RELATED APPLICATIONS

This application claims priority to U.S. Application No. 62/530,836, filed Jul. 10, 2017. This Application claims priority to U.S. Application No. 62/530,831, filed on Jul. 10, 2017 and herein incorporates by reference the same. This Application claims priority to U.S. Application No. 62/530,833, filed on Jul. 10, 2017 and herein incorporates by reference the same. This Application claims priority to U.S. Application No. 62/530,834, filed on Jul. 10, 2017 and herein incorporates by reference the same. Each of the foregoing Applications are incorporated by reference as if presented in their entirety.

### FIELD OF THE INVENTION

The present described systems, methods and computer products are directed to receiving, manipulating and generating visualizations of event venue access credentials for the purpose of optimizing computer-based event ticket sales.

### BACKGROUND OF THE INVENTION

The purchasing and selling of tickets for events are a common commercial enterprise conducted and made possible using the internet. While some events take place in open air areas, sometimes known as general admissions, in some circumstances, events take place in pre-defined event space where there are seats assigned to a given ticket holder. In these events, the price of tickets can be related to the location of the reserved seat associated therewith. Thus, it is advantageous for those engaged in event ticket transactions to have information about the relative location of a given seat or location that corresponds to the given ticket.

For example, venue maps are used to inform a ticket purchaser of the location of the seat associated with one or more tickets. Thus, as used herein, a venue map is a geographical interpretation of an event venue showing such information as the seats, rows and sections comprising an event space (e.g. a stadium). For example, a seat or venue map might show one or more contiguous set of seats in a given section. Here, a section is a contiguous set of rows of seats, typically separated by an aisle from other sections. However, such a simple geographic representation, when transmitted to remote users (such as internet users) does not allow for a full appreciation of the particular advantages or disadvantages of a given seat in a particular venue.

Thus, there exists in the art the need to provide more detailed information on the appropriateness of a given zone, as a collection of sections, as it relates to the price, availability or desirability of one or more collections of events tickets.

### SUMMARY OF THE INVENTION

The systems, methods and computer products described herein are directed to various novel methods of rendering venue information within a virtual map. In a further implementation, the systems, methods and computer products described herein are directed to rendering data relating to characteristics of venues, where such data is constantly updating. Generating such updated data is advantageous in both the sale of tickets, and in the display of information on the venue. For the latter, one possessing an ordinary level of skill in the requisite art will appreciate that pricing analytics, marketing and sales data can be improved by providing or showing historical sales data, expected sales data, difference between actual and expected sales data, available inventory on the market, or many other representations that focus on seat, row, section or zone level data.

In a particular, non-limiting configuration, an access credential inventory management system is provided. Such a system includes at least one database configured to store credential inventory data, wherein the credential inventory data includes at least a data object corresponding to each of the plurality of access credentials, wherein the data object includes a value indicative of the availability of the associated access credential. The system described also includes a processor having a memory and configured to access a virtual map of the given event wherein the virtual map includes a plurality of sections and/or unique locations. Through one or more additional modules, the processor is also configured to receive from one of the one or more remote databases the credential inventory data and assign, using the features associated with each of the plurality of access credentials, each of the plurality of access credentials to one of the plurality of sections of the virtual map. Using this data, the processor is further configured to generate a visual marker for each of the plurality of section as a function of the percentage of access credential available within a given section.

For instance, it is in one implementation of the system provided, a properly configured processor, computer or collection of computer systems represent the relative amount of a section sold within a venue in a familiar bar chart form by shading a percentage of the section corresponding to the amount of inventory available. For instance, if 30% of section 211 is sold, 30% of the pixels within the area bound by section 211 may be colored blue, whereas the remaining pixels are colored white.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating particular elements according to one embodiment of the present invention.

FIG. 2 presents a flow diagram detailing additional steps taken in one configuration of the access credential management system.

FIG. 3 presents a collection of modules detailing the operative functions of the access credential management system according to one configuration of the present invention.

FIG. 4 presents a graphical user interface details one or more operative functions of the access credential management system according to one configuration of the present invention.

### DETAILED DESCRIPTION OF CERTAIN EMBODIMENTS OF THE INVENTION

This application is herein incorporates by reference” U.S. patent application No. [TBD] and titled “Default Venue Maps” filed concurrently herewith and having attorney docket number 10153/006063-US1; U.S. patent application No. [TBD] and titled “System and Apparatus for the Display and Selection of Listings and Splits” filed concurrently herewith and having attorney docket number 10153/006064-US1; U.S. patent application No. [TBD] and titled “Automated Comparable-Based Pricing Using Non-Zero-Difference Comparables” filed concurrently herewith and having attorney docket number 10153/006065-US1. Each of the foregoing Applications are incorporated by reference as if presented in their entirety.

By way of overview and introduction, various embodiments of the systems and methods described herein are directed a computer system configured to evaluate and display data relating to one or more sources of information relating to particular locations within an event venue. In one non-limiting example, the systems and method described are directed to transforming information about price, availability and desirability of particular locations within a venue into visual data that can be displayed as an interactive virtual venue map. For example, such particular locations are aggregates of seats in a given area of a venue, such as a section. By producing a visualization of the virtual representation of a given venue using constantly updating dataset, users are more readily able to compare inventory levels in different sections than may not be obvious, for instance, by simply viewing seat-level data, in which the sold seats are scattered unevenly through the section, and are harder to compare

For convenience the phrase, “zone-level” refers to “at the zone scale”. Furthermore, as used throughout the term “access credential” can refer to a physical or electronic ticket or pass that grants the bearer access to an event or outing of which there is a defined and limited access. For example, access credential can be used herein to refer to a ticket for an event held at an arena, such as a professional, Olympic, or collegiate sporting event.

In one particular implementation, a system is provided that accesses event ticket data from one or more ticket databases. The information from the ticket database is transformed using data relating to the venue such that a visualization of data features relating to the tickets of a particular venue can be visualized on a virtual map of the venue. Such data transformations represent non-routine approaches to visualizing event transaction data and are an improvement over conventional and routine systems. Furthermore, such transformations represent an improvement in the technological functioning of access credential management systems as the quantity of data conveyed to each user can be streamlined to visual data, as opposed to a collection of discrete data points. Thus, a single reference image can provide the same level of information as a large table of data. In doing so, the present approach allows for more efficient management of electronic inventory and transactions where no physical inspection of such products is possible.

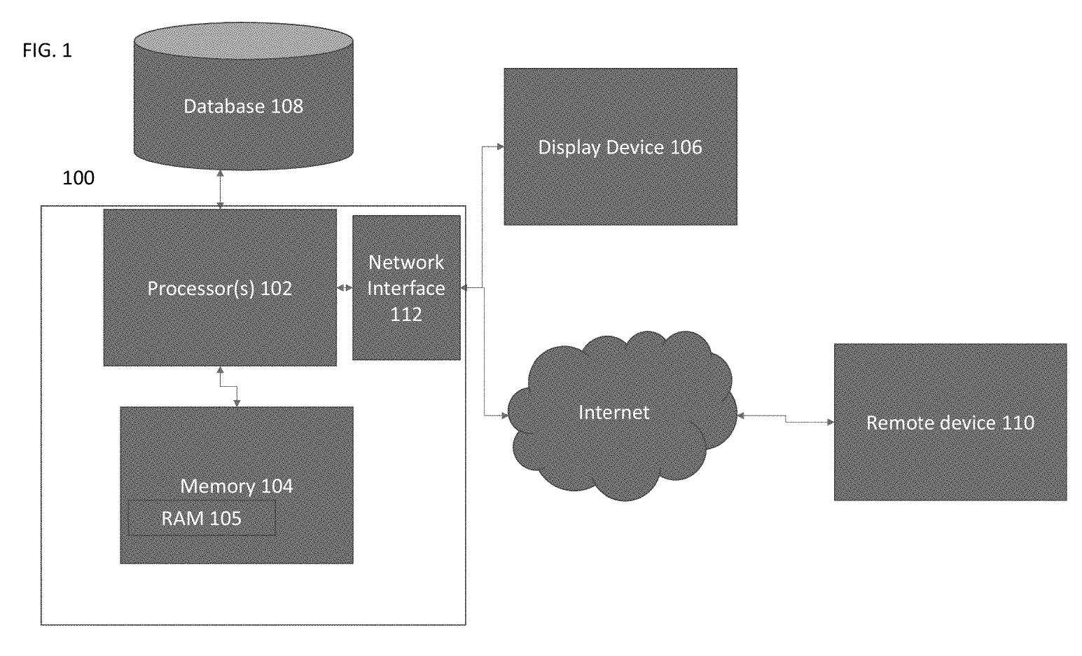

Turning to FIG. 1, a computer system 100 is provided to access, evaluate and transform data. In one or more configurations, the computer system 100 is composed of one (1) or more processors 102 configured to execute code residing therein. For instance, in one implementation, the computer system is a standard computing device such as, but not limited to, commercially available computing device. For example, the processor 102 may be a collection of computers, servers, processors, cloud-based computing elements, micro-computing elements, computer-on-chip(s), home entertainment consoles, media players, set-top boxes, prototyping devices or “hobby” computing elements.

Furthermore, the processor 102 can comprise a single processor, multiple discrete processors, a multi-core processor, or other type of processor(s) known to those of skill in the art, depending on the particular embodiment. In a particular example, the processor 102 executes software code on the hardware of a custom or commercially available cellphone, smartphone, notebook, workstation or desktop computer configured to receive data either directly from one or more memories or data storage devices, or indirectly through a communication linkage to one or more memories or data storage devices, such as database 108.

The processor 102 is configured to execute a commercially available or custom operating system, e.g., MICROSOFT WINDOWS, APPLE OSX, UNIX or Linux based operating system in order to carry out instructions or code.

In one or more implementations, the color processor 102 is further configured to access various peripheral devices and network interfaces. For instance, the processor 102 is configured to communicate over the internet with one or more remote servers, computers, peripherals or other hardware using standard or custom communication protocols and settings (e.g., TCP/IP, etc.).

The processor 102 may include one or more memory storage devices (memories). The memory is a persistent or non-persistent storage device (such as an IC memory element) that is operative to store the operating system in addition to one or more software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of the processor 104 provides for the storage of application program and data files. One or more memories provide program code that the processor 104 reads and executes upon receipt of a start, or initiation signal.

The computer memories may also comprise secondary computer memory, such as magnetic or optical disk drives or flash memory, that provide long term storage of data in a manner similar to a persistent memory device. In one or more embodiments, the memory of the processor 102 provides for storage of an application program and data files when needed.

In one implementation, each element provided in FIG. 1 is configured to communicate with one another through one or more direct connections, such as though a common bus. Alternatively, each element is configured to communicate with the others through network connections or interfaces, such as a local area network LAN or data cable connection. In an alternative implementation, the display device 106, processor 104, and database 108 are each connected to a network, such as the internet, and are configured to communicate and exchange data using commonly known and understood communication protocols.

In a particular implementation, the processor 102 is a computer, workstation, thin client or portable computing device such as an Apple iPad/iPhone® or Android® device or other commercially available mobile electronic device configured to receive and output data to or from database 108 and or a display device 106, or remote device 110.

Here, the processor 102 communicates with a display device 106 for displaying data as well as receiving input from hardware associated with the display device (such as a remote computing device) that permits a user to access information, and to send commands and/or instructions to the processor 102 and/or the database 108. In one or more implementations, the display device 106 is a screen, monitor, display, LED, LCD or OLED panel, augmented or virtual reality interface or an electronic ink-based display device.

Those possessing an ordinary level of skill in the requisite art will appreciate that additional features, such as power supplies, power sources, power management circuitry, control interfaces, relays, interfaces, and/or other elements used to supply power and interconnect electronic components and control activations are appreciated and understood to be incorporated.

As shown, memory 104 and persistent storage 108 are examples of computer-readable tangible storage devices. A storage device is any piece of hardware that is capable of storing information, such as, data, program code in functional form, and/or other suitable information on a temporary basis and/or permanent basis. In one or more embodiments, memory 104 includes random access memory (RAM) 105. RAM 105 may be used to store data such as the venue data in accordance with the present invention. In general, memory 104 can include any suitable volatile or non-volatile computer-readable storage device. Software and data are stored in persistent storage 108 for access and/or execution by processors 102 via one or more memories of memory 104. With respect to remote computing device 110, for example, software and data are stored locally on the remote computing device 110.

In a particular embodiment, persistent storage 108 includes a magnetic hard disk drive. Alternatively, or in addition to a magnetic hard disk drive, persistent storage 108 can include a solid state hard drive, a semiconductor storage device, read-only memory (ROM), erasable programmable read-only memory (EPROM), flash memory, or any other computer-readable storage devices capable of storing program instructions or digital information.

The database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art.

The media used by persistent storage 108 may also be removable. For example, a removable hard drive may be used for persistent storage 108. Other examples include optical and magnetic disks, thumb drives, and smart cards that are inserted into a drive for transfer onto another computer-readable storage medium that is also part of persistent storage 108.

Communications or network interface unit 112, in the forgoing examples, mediate communications with other sub-systems or devices. In an embodiment, communications unit 112 may provide appropriate interfaces to the Internet or other suitable data communications network to connect to one or more servers, resources, API hosts, or computers. In these examples, communications unit 112 may include one or more network interface cards. Communications unit 112 may provide communications through the use of either or both physical and wireless communications links.

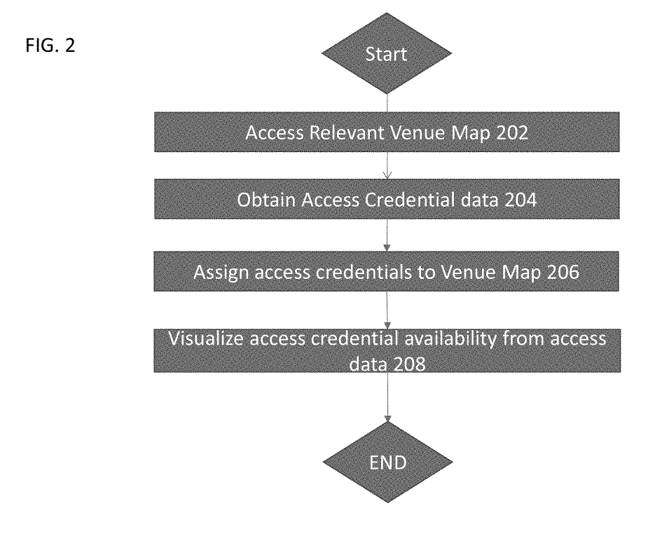

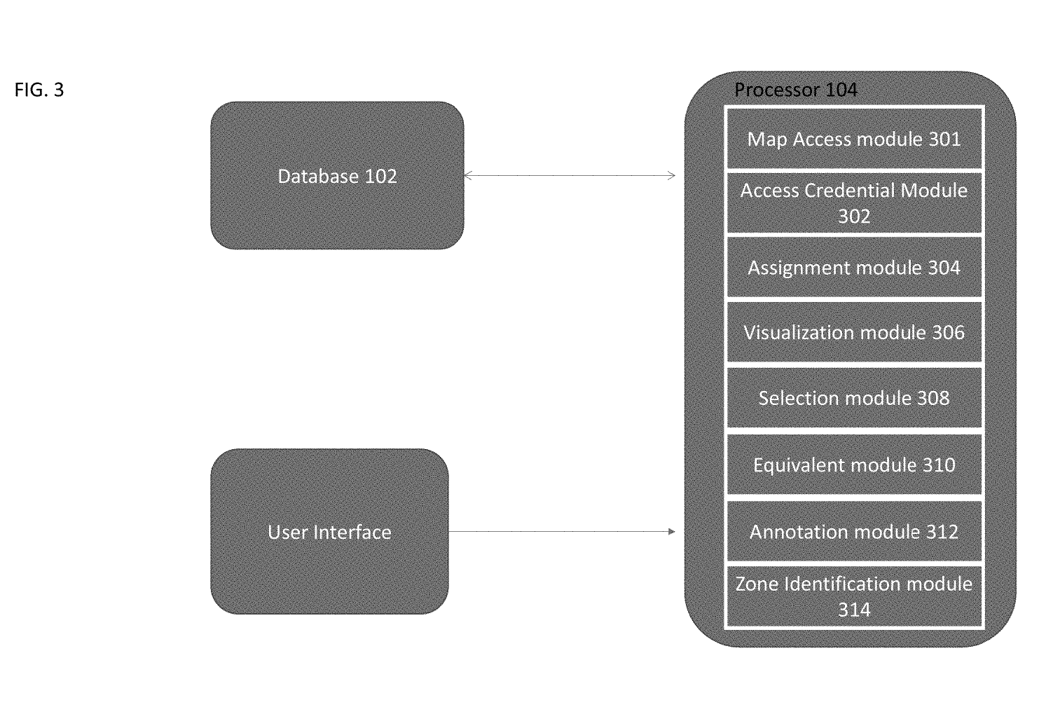

Turning to FIGS. 2 and 3, the systems and methods described herein provide, in one particular arrangement, a processor 102 configured by one or more modules, such as in the form of software modules executed as code by the processor(s) 102, to permit a user of a venue map to receive real-time and near-real time information as to the available inventory information for a given event.

In a particular, non-limiting configuration, an access credential inventory management system utilizes one or more processors 102. As shown, a processor 102 having a memory 104 that stores one or more modules (as shown in FIG. 3) is configured to access a virtual map of the given event. For example, as shown in step 202 of FIG. 2, the processor is configured by the map accesses module 301 to access a virtual map.

Here, the map access module 301 includes a collection of one or more submodules that configure the processor 102 to access a local or remote storage location, query a remote resource with the desired venue information, formatting and or other additional operating functions relevant to obtaining and displaying a virtual map of a desired event venue. For example, in one or more configurations, the venue map is accessed from a remote web host or server and is received as a data stream, file, binary string, JSON object, vector data, image data or another data format. Upon receipt by the processor 102, the event venue map is displayed on the display device 106, or stored in temporary or working memory for further processing. In yet a further configuration, the event venue map received by the processor 102 includes at least real-time inventory data associated with a particular event to be held at the event venue. In a further arrangement, the event venue data also includes historical data, GIS data, elevation data, cross-linked or directly linked image data and other venue data in real-time. Such data is received and formatted such that the event venue map may be presented to a user of the display device 106 or remote computing device 110.

The processor 102 is further configured though one or more modules to access or obtain access credential inventory information. Such a system includes at least one database configured to store access credential inventory data. In a particular implementation, access credential inventory data includes one or more data objects and/or values that correspond to each of the plurality of individual locations within an event (e.g. seats) that are, or have been, offered for sale for a given event to be held at the event venue. In one or more further implementations, the access credential inventory data further includes a value indicative of the availability to purchase a given access credential for the particular event held at the event venue.

Through one or more additional modules, the processor is also configured to receive from one of the one or more remote databases the credential inventory data. As shown in step 204, the processor 102 configured by the access credential module 302 is configured to retrieve from a remote database (e.g. database 108) access credential data. In one or more implementations, the access credential data includes at least a data object corresponding to each of the plurality of access credentials, wherein the data object includes a value indicative of the availability of the associated access credential. The access credential data is obtained in one or more configurations by accessing a primary event vendor computing system and receiving the relevant data. For example, the processor 102 is configured by one or more submodules of the access credential module 302 to initiate a remote connection to one or more vendors of the access credentials and receive information relating to the current inventory of access credentials as well as information relating to each access credential that was offered for sale for a particular event held at the event venue.

As used herein, the one or more features of the access credential data can include the price, location, date, time, particular seat or assigned location, additional perks (free parking—VIP access) and other information associated with a given event being held at the event venue.

Continuing with the flow diagram of FIG. 2, the processor 102 is configured by an assignment module 304 to assign, using the features associated with each of the plurality of access credentials, each of the plurality of access credentials to one of the plurality of sections of the virtual map. As shown in Step 206, the access credential data features corresponding to a particular location (e.g. seat number) are used link the given access credential to the specific section of the venue map.

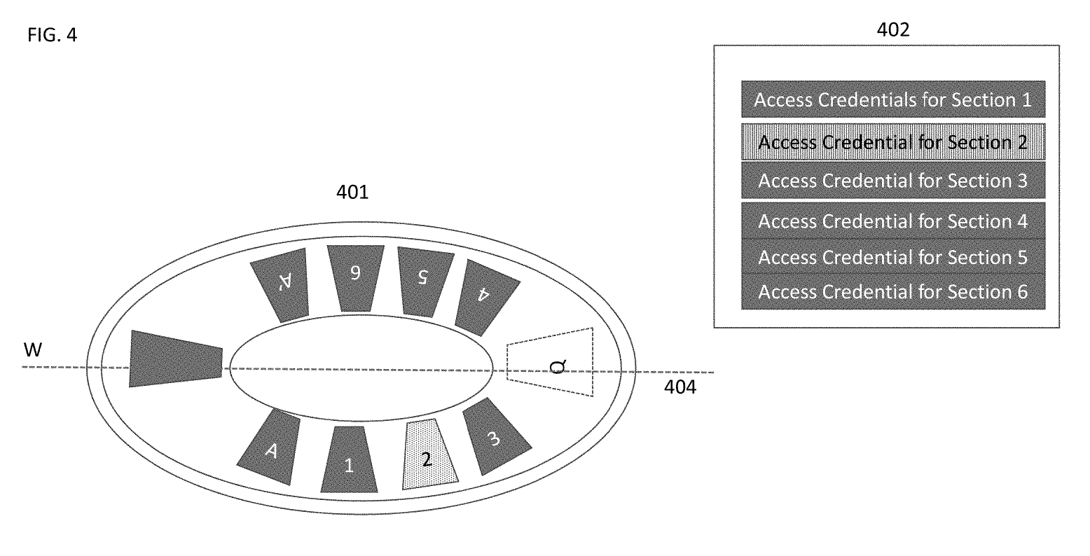

In one particular implementation, the venue map, as shown in FIG. 4, has pre-defined sections (A, A′, 2-6). In this arrangement the venue itself provides both the venue map as well as the data features associated with each of the access credentials that indicates a location of the referenced unique location according to venue provided coordinates. However, in circumstances where there are no pre-defined sections of the venue map, the corresponding access credentials will not have “section” level feature data. In this arrangement the assignment module 304 is configured to assign each of the access credentials to a defined section of the venue map. For example, using historical data relating to the relative location of seat with respect to the featured event (e.g. the main stage of a concert) access credentials can be grouped based on seat data into a section. Likewise, pricing data can be used to group different access credentials. For example, where price of the access credentials can be used to determine the relative rarity or desirability of a given access credential, such pricing can be used to group similarly priced access credentials. In further iterations, both price and historical data are used to group access credentials into a section. Likewise, survey data (such as a third-party resource) is used to locate a particular access credential within a venue such that all access credentials that are placed within a similar location are deemed to be in a given section. For example, images linked to the access credential data can be used, extracted or manipulated to determine the relative location of one or more access credentials

In a further implementation, the processor 102 is configured to generate a visual marker for each of the plurality of sections of the venue map. For example, each identified section of the venue maps is assigned the same default color. Then, the processor 102 is configured by a visualization module 306 to alter the color of each section as a function of the percentage of access credential available within a given section. By way of non-limiting example, where the generated visual marker is generated by assigning each sector a default color value, and where the color value is a RGB color, then the processor 102 is configured to adjust the color value of at least one of the RGB tri-stimulus values as a function of the percentage of access credentials available in the given section. For example, section 2 of the event venue map (401) of FIG. 4 is shown as having less access credential for sale than the remaining sections.

As shown in step 208, the access credential information provides a value for each of the access credentials that is indicative of the relative amount of access credentials still available within a given section. For example, because the total number of access credentials are known (such as received as part of the access credential dataset), and each access credential includes a data value indicating its availability, this data can be used to determine on a section-by-section basis, the relative availability of each section. For example, by altering the base color in response to the percentage of access credentials still available, the visualization allows for users to determine which section has the most remaining seats.

In one or more further implementations, the visualization module 306, or one or more submodules thereof, configure the processor 102 to generate one or more metrics relating to the access credential dataset and display the metrics along with the virtual map. For instance, the processor 102 is configured by the visualization module 306 to generate one or more values indicative of the total market position or price of an event or venue based on the access credential dataset. For example, the graphical user interface of FIG. 4, provides both a venue map 401 and a market listing window 402. Here, the market listing window includes a visual identifier that also indicates that section 2 is almost sold out. However, other indicators can be used to provide information relating to the market cap or other metrics of the inventor offered for sale.

In no way limiting to the disclosures provided herein, the term “market cap” can be used as an abbreviation for “market capitalization”, which is the total number of outstanding shares of a company multiplied by the share price. In one or more configurations, the processor 102 is configured to generate or calculate the market cap of the access credentials by (a) gathering the information necessary to calculate the market cap, (b) applying the formula outlined above to compute a value, (c) storing that value in a database, and (d) sending a message from a server to a browser containing a representation of the market cap or the data necessary to compute it, and (e) rendering the market cap in a user interface or transmitting the data to a local or remote computing device for further use.

In accordance with one or more aspects of the system described, the processor 102 is configured by the visualization module 306 to calculate a set of similar metrics that represent the “market cap” or the sum of all the sale prices of the tickets for an event. For example, if an access credential (e.g. season ticket) was sold, but not resold on a secondary market, one of the following metrics may be calculated for the access credentials: (a) an estimated price for the access credential based, in part, on the number of events that the access credential can be used to access (e.g. prorated for the event based on the number of events the ticket is valid for at the onset of the season), (b) an estimated price based on a weighted average of the market cap for the remaining events the access credential will provide access, or (c) $0.

The processor 102 configured by the visualization module 306 is further configured to generate or calculate a value indicating a “asking market cap” value. Here, the asking market cap value represents the sum of the sale prices of the access credentials available for an event plus the sum of all the current offers in the market for unsold access credential for that event. This may be advantageously used prior to an event, while tickets are still on sale. Access credential that can be used for more than one consecutive event (e.g. season tickets) can likewise be handled in a similar fashion.

The properly configured processor 102 is further configured to generate or calculate the “estimated market cap” as a predicted value, or set of predicted values, for the sale price of tickets available for an event, which considers various factors that predict the eventual sale price of tickets, a prediction for the amount of unsold tickets, including predictions for season tickets. For example, the processor 102 is configured by the visualization module 306 to preform machine learning, neural network, or other statistical analysis on historical data to provide an estimated value of a particular access credential based on the data features associated therewith.

In one or more further implementations, the processor 102 is configured by the visualization module to render data on the venue map at the seat, listing, row, section, zone or selected region level. Here, data may include any metric computed relative to any one or more access credential. For example, using data accessed from one or more databases of present and historical access credentials for a given venue, sale data or market listing data is visualized. For example, the present and historical data may be generated and displayed based on, inter alia, historical data, predicted data, estimated data, actual data collected from sources such as market reports, ticket exchanges, ticket point-of-sales. The data visualized may also include qualitative data, such as user sentiment related to the quality of seats within the object, the relative value of the object, or other softer measures. The representation of such data may be by visually modifying a portion of the venue map in proportion to the value calculated. For instance, the percentage of tickets sold in a zone may be represented by shading that percentage of the zone with a different color as a function on one or more features of the access credentials. For example, where the desirability of a given section of collection of seats corresponding to a collection of access credentials is determined to be low, the visual identifier may be altered to reflect this data. Such alterations can take the form of changes to the shape, line weight, or coloring of a represented element of the venue map (such as a seat). For instance, where a section or zone border is changed from solid to dashed lines to represent various specific data unique to that section. For example, section Q of the venue map 401 is displayed in dashed line to indicate that sections historical undesirability.

In a further implementation, data may also be represented in textual form, rendered directly on the object represented by the data. For instance, a set of metrics related to a section's sales data may be rendered on the section itself.

In yet a further implementation, data may also be represented with a graph, rendered directly on the object represented by the data. For instance, a graph with an x-axis of data and a y-axis of percentage of tickets sold for the object can be rendered directly on the object.

As described, in one or more implementations, a user is provided with visualization information that indicates that the preferred access credential (e.g. seat) has already been sold or is no longer available. Thus, in a further iteration, the access credential data is used to generate additional visualizations of the data so as to permit improved analysis and understanding of the relative price, desirability and availability of a given section of a venue.

For example, the prior art is replete with examples of identifying data at an individual user level (e.g. the seat level). The presently described approaches utilize section level data to simplify comparisons between blocks of seats.

At present, venue maps allow a user (such as a user connected to the processor 102 via a remote computing device) to select various unique locations at the seat, row or section level. Selection is typically done by clicking or the touch equivalent of the unique location. In one or more implementations, the system and methods described herein permits a user to instruct the processor 102 to select a region of the venue map 401, and have that information displayed on either the display device 106 or on the display of the remote device 110. For example, the processor 102 is configured by a selection module 308 that permits the user to draw using freehand or using predefined shapes on the map displayed on a screen, such as display device 106. Here, the shapes drawn or provided define a collection of data objects represented by one or more pixels on the display device. For example, the venue map 401 is a collection of vector lines or shapes, such selection to generate an array of selected shapes and any associated metadata or identifiers provided therewith. Where the selection shape partially captures an object (for example by a determination that the selection shape intersects a given vector shape), the user is provided with a prompt permitting the user to either (a) include or (b) exclude the objects that are partially selected. In this context, objects include, inter alia, one or more listings, seats, rows, sections, and zones. For example, the remote computing device 110 is configured to send one or more data elements, such as vectors, to the processor 102. In turn, the processor 102 is configured by the selection module 308 to transform the vectors into a series of queries. Here, selection of a region causes an update or modification of a representation provided by a user interface (UI), such as a user interface displayed on the remote computing device 110.

In a further implementation, in response to receiving a user's selection of a section or region of the venue map, the processor 102 is configured to access the most current version of the credential access data set. In yet a further implementation, the selection of a region using freehand or provided shapes causes the processor 102 to implement one or more data transformations to be performed by the processor 102. In a further implementation, the selection of an area of the virtual event venue map 401 permits any combination of the above action to be initiated by a properly configured processor 102.

In a particular implementation upon selection of a specific region within the event venue map, the processor 102 configured by an equivalent module 310 also selects one or more locations having a reciprocal or mirrored placement within the venue map. For instance, the processor 102 is configured to identify one or more access credentials having a location that represents a spatial transformation of the present location within the venue map 401. For example, where the area is aligned to one side along a given axis (line W of FIG. 4), the processor configured by the mirror module 310 is configured to identify access credentials that are aligned along the other side of the axis. For example, upon selection of Section A, Section A′ is also selected or highlighted. In a further implementation, the processor 102 automatically selects the locations representing mirror placement within the venue of a user selected location. Both selections, the processor selection and the user selection, are transformed with a visualization to indicate that they have been selected.

By way or further example, where the virtual venue map 401 is a depiction of an elliptical stadium, the selection of a location or object within the virtual map (such as Section A) causes processor 102, configured by the equivalent module 310, to identify additional available access credentials that are an equal distance away from a common landmark. By way of non-limiting example, where the virtual venue map is related to a United States football game, selecting a section (or individual access control) also causes the selection of a section (or individual access control) in the same position but reflected around the 50-yard line. In yet a further implementation, a processor 102 configured by the equivalent module 310, determines a pre-determined distance to a point of interest (e.g. the 50-yard line) and selects the section or seat referenced by a given access credential in the same position, but reflected across the field on the opposite side of the stadium. In an alternative configuration, a properly configured processor 102 selects the object in the same position but reflected around the 50-yard line and on the opposite side of the stadium. In a further implementation, a properly configured processor 102 selects any combination of the above. In still a further implementation, where the common landmark or point of interest in a stadium is a specific team's end zone, the selection of one object will cause the selection of all other object similarly situated the same distance from the end zone as the initially selected object.

It should be understood by those with ordinary skill in the art that the description of the United States football game is a convenience for describing the geometry, and that the description applies analogously to other games and other venue types. In general, a set of mirror symmetries can be established for a venue, and selection of an particular location causes the processor to determine and identify any combination of the sections that have one or more mirror symmetries to the selected location. For example, the database 108 includes one or more lists, linked lists, data objects, or data sets associated with one or more points of interest for a given venue. The database 108 further includes GIS or spatial data for the venue in question. For example, the database 108 includes height, width and lengths of various structural features of the venue. A properly configured processor 102 is configured to evaluate each location within the venue map (such as seats) and calculate based on the venue map data the spatial relationships between the locations, in both 2 and 3 dimensions.

In another example, the venue is a baseball stadium virtual map. Here a properly configured processor 102 is configured to select objects around the line extending from the pitcher's mound to home plate and extended to the length of the stadium. Such a reflection allows the selection of a seat closest to first base to also select the seat closest to third base, since this is mirror symmetric to the line bisecting the venue that passes both through the pitcher's mound and home plate.

Row Labeling

In one or more further implementations, a processor 102 is configured by an annotation module 312. Here, the processor is configured to generate virtual labels or annotations on collections of locations referenced by the access credential (e.g. rows of seats) within the virtual venue map. In one particular implementation, the generated annotations include text indicating the row number or some other spatial identifier provided by the venue. Those possessing an ordinary level of skill in the requite art will appreciate that access credential (e.g. tickets) can include spatial identifiers (e.g. row numbers) that are confusing without context additional context. By way of non-limiting example, a given section within a venue may be “numbered” from front to back with fairly complex rules, such as “AA, BB, CC, DD, A, B, C, D, E, 1, 2, 3, 4, 5, 6, Z, ZZ”. Thus, users selecting an event credential may inadvertently purchase access credentials having a seat designation in “row 1” only to find that the themselves 10 rows back. Thus, the annotation module 312 configures the processor 102 to access information about numbering and naming conventions for a given venue and provides the relevant numbering convention to the virtual map. In this way, the user of the map has their attention drawn to possibly unusual number system such that when a purchase is selected, they are assured of the desired location.

In a further implementation, the processor 102 is configured by a zone identification module 314. Here, the configured processor 102 renders, upon receiving an input (such as but not limited to data received from the remote device 106), a polygon around the sections comprising the zone of inquiry. The processor 102 is then further configured by one or more submodules of the zone identification module 314 to visually distinguishing the sections in one zone from another. For example, the processor 102 is configured by code to modify the tint, shade, color, background pattern, foreground pattern, shape, or modifying the seat, row or section visual representation differently from one zone to the next. In an alternative configuration, the processor 102 is configured to modify the representation of a zone in response to a user action such as a mouse-over event or clicking within the zone. Additionally, the processor 102 is configured to select a related UI element, such as a listing description in a separate part of a UI that then modifies the venue map to highlight the zone containing the listing. It should be appreciated that a the properly configured processor 102 executes any combination of the described procedures. The zones may be assigned by the venue, by some other party, or by the user of a UI. The definition of a zone may change over time.

Thus, it should be appreciated that while venues often group sections into zones of comparable value, there is no ability for a user to obtain information relating to zone as a function of the access credentials offered within the given zone. The described systems and methods allow for users to accurately define and evaluate the access credential inventory for an event held at an event venue. As the internet makes it possible to engage in transactions without actual presence, the danger that the wrong tickets are purchased has increased substantially. Thus, the presently described systems and methods correct for such problems inherent in internet-based ticket acquisition. Furthermore, individuals who lack access to information regarding to desirability of a particular location within a particular event venue are thus able to identify equivalent locations within the event venue.

As used herein, processors, computing elements and microprocessors described herein are, in one or more implementations, connected, directly or indirectly, to one or more memory storage devices (memories). The memory is a persistent or non-persistent storage device that is operative to store an operating system for the processor in addition to one or more of software modules. In accordance with one or more embodiments, the memory comprises one or more volatile and/or non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. The computer memories may also comprise secondary computer memory, such as magnetic or optical disk drives or flash memory, that provide long term storage of data in a manner similar to the persistent memory device. In one or more embodiments, the memories of the processors provide for storage of application programs and data files when needed.

It will be further appreciated that computers, processors or computing devices described herein can communicate with the one or more remote networks using USB, digital input/output pins, eSATA, parallel ports, serial ports, FIREWIRE, Wi-Fi, Bluetooth, or other communication interfaces. In a particular configuration, computing devices, processors or computers provided herein may be further configurable through hardware and software modules so as to connect to one or more remote servers, computers, peripherals or other hardware using standard or custom communication protocols and settings (e.g., TCP/IP, etc.) either through a local or remote network or through the Internet. Computing devices, processors or computers provided herein may utilizes wired or wireless communication means, such as, but not limited to CDMA, GSM, Ethernet, Wi-Fi, Bluetooth, USB, serial communication protocols and hardware to connect to one or more access points, exchanges, network nodes or network routers.

Those possessing an ordinary level of skill in the requisite art will appreciate that the where the present invention is a system, a method, and/or a computer program product, the he computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Haskell, R, Clojure, javascript, C#, Swift, Lua, Pearl, Python, Ruby, or the like, and conventional procedural programming languages, such as the “C” programming language, object-oriented programming languages, functional programming languages or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The block diagrams in the illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments may be utilized in many different types of data processing environments. In order to provide a context for the description of the specific elements and functionality of the illustrative embodiments, are provided hereafter as example environments in which aspects of the illustrative embodiments may be implemented. It should be appreciated that are only examples and are not intended to assert or imply any limitation with regard to the environments in which aspects or embodiments of the present invention may be implemented. Many modifications to the depicted environments may be made without departing from the spirit and scope of the present invention.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying FIGs. do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those points, and by equivalents of such features.

What is claimed is:

1. An access credential inventory management system comprising:
at least one databases configured to store credential inventory data, wherein the credential inventory data includes at least a data object corresponding to each of the plurality of access credentials, wherein the data object includes a value indicative of the availability of the associated access credential; and
a processor having a memory and configured to:
access a virtual map of the given event venue wherein the virtual map includes a plurality of sections;
receive from one of the one or more remote databases the credential inventory data;
assign, using the features associated with each of the plurality of access credentials, each of the plurality of access credentials to one of the plurality of sections of the virtual map; and
generate a visual marker for each of the plurality of sections as a function of the percentage of access credential available within a given section.

2. The system of claim 1, where the processor is further configured to:
receive a selection of one of the sections;
determine an identification landmark within the accessed venue map; and
calculate a vector distance between the identification landmark and the selection selected section.

3. The system of claim 2, where the processor is further configured to:
Iterate over each of the non-selected sections and calculate a vector distance between the non-selected sections and the identification landmark; and
generate a visual marker for each non-selected section that has a distance value that is within a pre-determined threshold value of the of the selected section.

4. The system of claim 3, wherein the identification landmark corresponds to a physical landmark within venue represented by the virtual venue map.

5. The system of claim 1, where the processor is further configured to update the generated visual marker upon receiving updated credential inventory data.

6. The system of claim 1, where the generated visual marker is generated by assigning each sector a default color value, where the color value is a RGB color, and adjusting the color value of at least one of the RGB tri-stimulus values as a function of the percentage of access credentials available in the given section.

7. A method of visualizing event venue credentials comprising:
accessing, using a processor having a memory, a virtual map of the given event venue wherein the virtual map includes a plurality of sections and a plurality of unique locations within each section;
receiving, from one of the one or more remote databases, a credential inventory dataset; wherein credential inventory data includes at least a data object corresponding to each of a plurality of access credentials for a given event, and the data object includes a value indicative of the availability of the each of the plurality of access credentials and the unique location associated with each of the plurality of access credentials; and
assigning using the features associated with each of the plurality of access credentials, each of the plurality of access credentials to one of the plurality of sections of the virtual map.

8. The method of claim 7, further comprising:
receiving an input from a remote access device of one of the unique locations within one of the plurality of sections:
determining from the plurality of access credentials, each access credential that is within a similarity threshold of the received input location; and
generating a visual marker for each of the plurality of identified unique locations that are within the similarity threshold of the selected unique location.

9. The method of claim 8, wherein the visual marker for each of the plurality of identified unique locations is generated as a function of the percentage of similarity to the selected unique location.

10. The method of claim 8, wherein the color of the visual marker for each of the similar locations is function of the degree of similarity with the selected unique location.

11. The method of claim 7, where the processor is further configured to:
receive a selection of one of the sections;
determine an identification landmark within the accessed venue map; and calculate a vector distance between the identification landmark and the selection selected section.

12. The method of claim 11, further comprising:
iterating over each of the non-selected sections and calculate a vector distance between the non-selected sections and the identification landmark; and
generating a visual marker for each non-selected section that has a distance value that is within a pre-determined threshold value of the of the selected section.

13. The method of claim 12, wherein the identification landmark corresponds to a physical landmark within venue represented by the virtual venue map.

14. The method of claim 7, where the processor is further configured to update the generated visual marker upon receiving updated credential inventory data.

15. The system of claim 14, where the generated visual marker is generated by assigning each sector a default color value, where the color value is a RGB color, and adjusting the color value of at least one of the RGB tri-stimulus values as a function of the percentage of access credentials available in the given section.
